(19) United States
(12) Patent Application Publication
(10) Pub. No.: US 2012/0087141 A1
(43) Pub. Date: Apr. 12, 2012

(54) Trouble light advanced

(76) Inventor: Wilfred P. Rancourt, Citrus Springs, FL (US)

(21) Appl. No.: 12/592,514

(22) Filed: Nov. 27, 2009

(51) Int. Cl. F21V 21/096

(52) U.S. Cl. 362/398

(57) ABSTRACT

The trouble light simply incorporates a magnet on the rear of a standard trouble light

The magnet allows the lamp to be positioned in numerous stable positions.

The old light with the hook was almost impossible to position correctly.

The standard trouble light that had been in use for many decades.

Showing the invention that is a formed magnet attached to the rear of the trouble light

The problem with the old light was, no matter where you hung the curved hook on any surface, % 90 of the time the lamp would shift and never shine where you want it

The magnet adhered to the rear of the lamp allows it to be stationary most of the time.

The shape of the magnet may be altered to fit different requirements.

One possibility is a magnet with 4 or 5 facets, also the strength of the magnetic field may be changed, the field strength on the pictured unit is 400 gauss.

### LIST OF VIEWS

FIG. [1] A front view of the old normal trouble light

FIG. [2] A left side view of the light showing the edge of the magnet.

FIG. [3] A right side view of light showing the edge of the magnet.

FIG. [4] A rear view of the light with with the magnet attached.

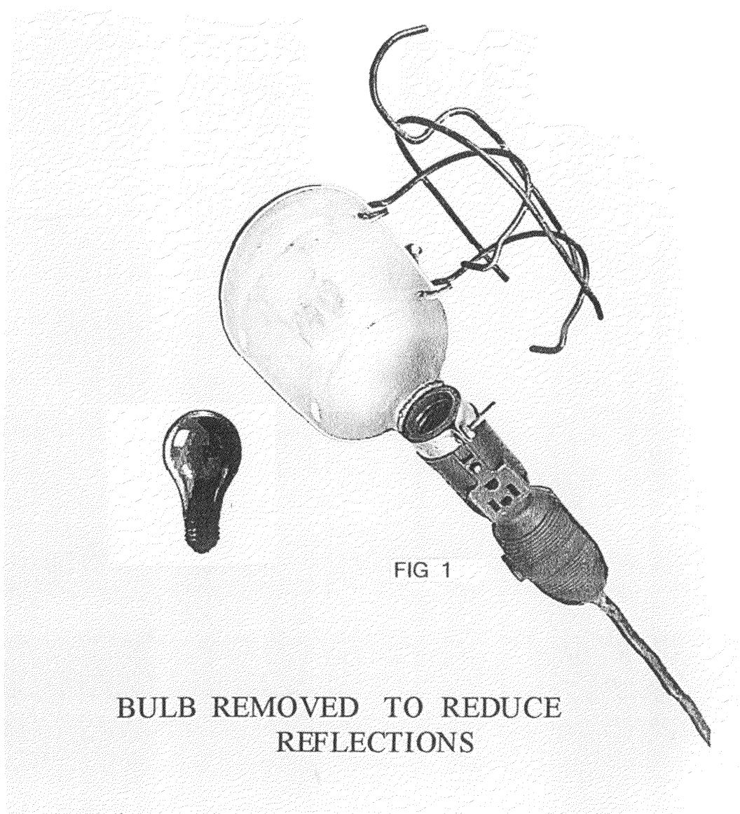

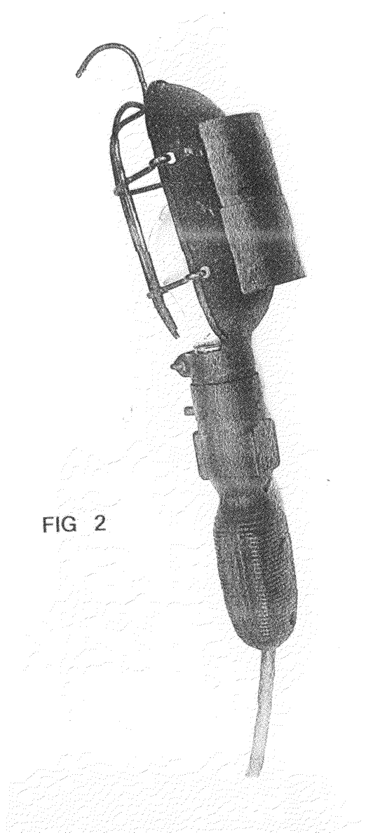

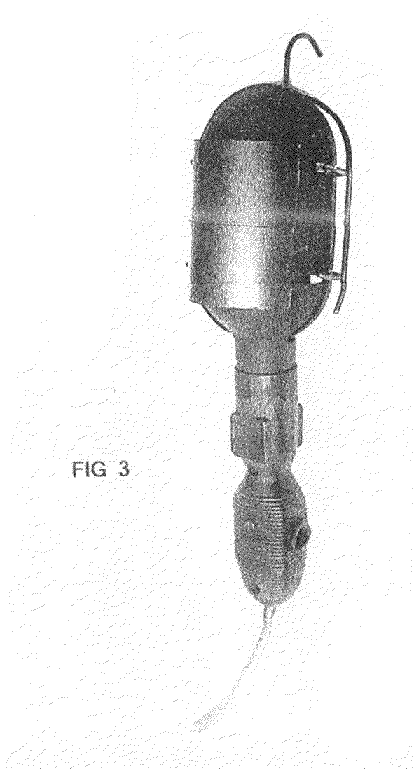

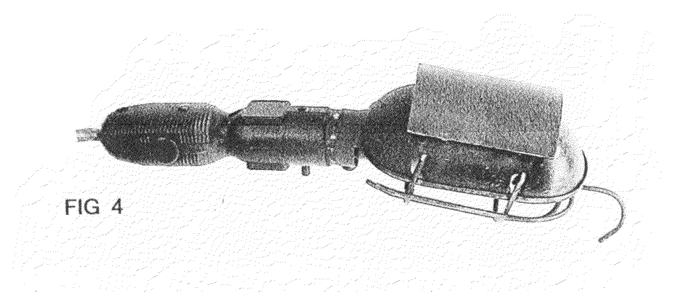

Note FIG. 3 Is the preferred view to publish

1. The addition of a magnetic material to the well known trouble light enhances its positioning stability and versatility as to placing the light source in the correct location.
The magnet may be manufactured in any shape and any gauss number [strength] that the manufacture deems appropriate for his requirement
The magnet may be bonded, screwed or riveted to the rear of the trouble light, but not limited to all of the above.
